(19) United States
(12) Patent Application Publication
(10) Pub. No.: US 2020/0316531 A1
(43) Pub. Date: Oct. 8, 2020

(54) Composite Membrane for Industrial Water Filtration

(71) Applicant: Esquel Enterprises, Limited, Hong Kong (HK)

(72) Inventors: Yugao ZHANG, Hong Kong (HK); Xi DU, Hong Kong (HK); Yan KE, Hong Kong (HK); Xiaoqian ZHU, Hong Kong (HK); Siyue LI, Hong Kong (HK); Yingshun LI, Hong Kong (HK)

(21) Appl. No.: 16/827,992

(22) Filed: Mar. 24, 2020

Related U.S. Application Data
(60) Provisional application No. 62/830,970, filed on Apr. 8, 2019.

(51) Int. Cl. B01D 69/10; B01D 61/02; B01D 71/68; B01D 71/56; C02F 1/44; B01D 67/00; B01D 69/12; D01D 5/00; D01F 6/96; D01F 6/60

(52) U.S. Cl. CPC B01D 69/10; B01D 61/027; B01D 71/68; B01D 71/56; C02F 1/442; B01D 2323/26; B01D 69/12; D01D 5/0007; D01F 6/96; D01F 6/60; B01D 2323/39; B01D 67/0002

(57) ABSTRACT

An industrial wastewater filtration membrane and method for manufacture is disclosed herein. The membrane has three layers: a support layer of nonwoven fabric such as PET, a polysulfone nanofiber filtering membrane layer, and a nanoporous polyamide active separating layer. The polysulfone layer is electrospun onto the support layer. The polyamide layer is electrosprayed onto the polysulfone layer. The resulting membrane has a pure water flux rate of at 0.48 MPa that is between 40-200 liters per square meter per hour, a rejection rate of sodium chloride of 10-85% with inlet sodium chloride concentration of 2000 ppm, and a rejection rate of magnesium sulphate of 80-97% with inlet magnesium sulphate concentration of 2000 ppm.

### CROSS-REFERENCE TO RELATED APPLICATIONS

This application claims the benefit of filing of U.S. Provisional Patent App. No. 62/830,970 filed on Apr. 8, 2019.

### BACKGROUND ART

The product and methods disclosed herein are for use in water filtration. More particularly, the apparatus is a nanofiltration membrane used for water treatment or filtration in textile manufacturing.

Purification of industrial wastewater for re-use in industrial, agricultural or environmental use or human consumption is a global priority as water resources become more scarce. Membranous water filtrators have been known and commercialized. However, conventional phase-inversion or thin-film composite membranes have a low water flux rate, making them inefficient for high-volume industrial applications. The water flux rate is a measurement of permeation and volume flow rate of water through a membrane of a given cross-sectional area (i.e., the volume of water that can be filtered over a given time period). Membranes engineered on a nanoscale may increase the water flux rate, but they also can have high manufacturing and operational costs.

What is needed, then, is a nanoscale filtration membrane having a high flux rate and with a low manufacturing cost for mass production. The products and methods disclosed herein use nanofibers to fabricate a highly porous membrane with high flux rate and salt rejection.

### SUMMARY OF THE INVENTION

An industrial wastewater filtration membrane and method for manufacture are disclosed herein. The membrane has at least three layers: a support layer of nonwoven fabric such as PET, a polysulfone nanofiber filtering membrane layer, and a nanoporous polyamide active separating layer. The polysulfone layer is electrospun onto the support layer. The very thin polyamide layer having a thickness of 10 to 100 nm is formed by contemporaneously electrospraying two reagent solutions onto the polysulfone layer. The resulting membrane has a pure water flux rate between 40-200 liters per square meter per hour when the pressure is between 0.4 to 0.8 MPa. The membrane shows a rejection rate of sodium chloride of 10-85% with inlet sodium chloride concentration of 2000 ppm, and a rejection rate of magnesium sulphate of 80-97% with inlet magnesium sulphate concentration of 2000 ppm. Differences in rejection rates are based on varying the composition and manufacturing methods as described herein. The membrane has industrial application for industrial water treatment or softening of hard water.

A method for manufacturing a nanofiltration membrane is disclosed having the steps of providing a support layer of nonwoven fabric; electrospinning a polysulfone filtering membrane layer onto the support layer; and electrospraying a nanoporous polyamide membrane active separating layer onto the filtering membrane layer, according to an embodiment of the invention.

A filtration membrane is disclosed having a support layer of nonwoven fabric, a nanofiber polysulfone filtering membrane layer applied to a surface of the support layer; and a nanoporous polyamide membrane active separating layer, according to an embodiment of the invention. The support layer may be a PET fabric. The filtering membrane layer may be formed of polyethylsulfone (PES) nanofibers. The active separating layer may be made by polymer condensation of molecules of DETA and/or TEGDA, and TMC.

Other characteristics or performance parameters of the disclosed membrane are provided herein.

### BRIEF DESCRIPTION OF THE DRAWINGS

FIG. 1 depicts an SEM microscopic image at 1000× magnification of PES nanofiber formed by electrospinning a 25% by weight PES in DMF solution in accordance with an embodiment of the invention.

FIG. 2 depicts an SEM microscopic image at 5000× magnification of PES nanofiber formed by electrospinning a 23% by weight PES in DMAc solution in accordance with an embodiment of the invention.

FIG. 3 depicts an SEM microscopic image at 1000× magnification of a polyamide active separating layer formed by electrospraying a solution of 1.5% by weight TEGDA dissolved in de-ionized water and a solution of 0.15% by weight TMC dissolved in hexane, in accordance with an embodiment of the invention.

FIG. 4 depicts an SEM microscopic image at 1000× magnification of a polyamide active separating layer formed by electrospraying a solution of 1.5% by weight of DETA dissolved in de-ionized water and a solution of 0.15% by weight TMC dissolved in hexane, in accordance with an embodiment of the invention.

FIG. 5 depicts an SEM microscopic image at 1000× magnification of a polyamide active separating layer formed by electrospraying a solution of 1.5% by weight of DETA and TEGDA in a mix ratio of 4:6 dissolved in de-ionized water, and a solution of 0.15% by weight TMC dissolved in hexane, in accordance with an embodiment of the invention.

FIG. 6 depicts an SEM microscopic image at 1000× magnification of a polyamide active separating layer formed by electrospraying a solution of 1.5% by weight of DETA and TEGDA in a mix ratio of 3:7 dissolved in de-ionized water, and a solution of 0.15% by weight TMC dissolved in hexane, in accordance with an embodiment of the invention.

FIG. 7 depicts an SEM microscopic image at 1000× magnification of a polyamide active separating layer formed by electrospraying a solution of 1.5% by weight of DETA and TEGDA in a mix ratio of 2:8 dissolved in de-ionized water, and a solution of 0.15% by weight TMC dissolved in hexane, in accordance with an embodiment of the invention.

FIG. 8 depicts the result of a sessile drop test using water droplets on a membrane having a smooth surface.

FIG. 9 depicts the result of a sessile drop test using water droplets on a membrane having a rough surface.

FIG. 10 depicts a schematic operation of an electrospin/electrospray apparatus used in the fabrication of the filtration membranes.

### DETAILED DESCRIPTION OF THE INVENTION

Disclosed herein is a nanofiltration membrane for use in water filtration. The membrane is currently considered for water filtration in the textile manufacturing industry, however, it is possible the membrane may be used in other industries as well. The membrane filters and removes ions, particles, and impurities present in industrial water.

The membrane described herein has three primary layers. The first layer is a support layer. The second layer is a nanofibrous membrane applied during manufacture of the membrane to the underlying support layer. The third layer is an active separating layer. Other layers or filtration mechanisms may be applied without limiting the generality of the foregoing.

The first layer, the support layer, is a suitable non-woven fabric for supporting the second layer that is applied to it. In some embodiments, the non-woven fabric is a polyethylene terephthalate (PET or, more popularly, polyester). PET fabric is selected because of its water resistance, chemical resistance and high strength-to-weight ratio. Other fabrics having similar qualities may also be selected. The PET fabric may have a thickness between approximately 0.1 mm and 0.25 mm. The PET fabric may have a density between approximately 20 grams per square meter and 50 grams per square meter. The density and thickness of the PET fabric affect the strength of the resulting support layer.

The second layer of the filtration membrane is an electrospun nanofibrous filtering membrane. In some embodiments the filtering membrane is made of polyether sulfone (PES). Other polysulfones may be used as well. The nanofibers are spun directly onto the nonwoven fabric support layer. For the electrospinning process, the PES is dissolved in a dimethylformamide (DMF) or N,N-dimethylacetamide (DMAc) solution. The liquid solution is then electrostatically spun to apply nanofiber strands of PES to the nonwoven fabric layer. In some embodiments the PES nanofibers are fabricated by electrospinning a 20%-30% solution of PES in either DMF or DMAc, where the PES has a molecular weight of approximately 50,000 Da. The resulting nanofibers have a diameter between 100-2000 nm and form a PES layer having a thickness between 0.03-0.06 mm. In some embodiments the electrospinning working voltage for this application is in the range of about 40-50 kV. In some embodiments the working distance for this application is about 150-200 mm. The solution may be fed into the electrospinning machine nozzle at about 0.5-1 ml per hour.

The third layer of the filtration membrane is an active separating layer applied over the filtering membrane. The active separating layer is formed of amine and acyl chloride monomers that are condensed into a thin membrane or layer atop the filtering membrane. In some embodiments the amines selected are diethylenetriamine (DETA), 1,8-diamino-3,6-dioxaoctaine (TEGDA), or a combined mixture of DETA and TEGDA, provided in aqueous solution. Other amines may also be used. In some embodiments the acyl chloride is a hexane solution of trimesoyl chloride (TMC). Other acyl chlorides may also be used. The selected amine and acyl chloride solutions are then electrosprayed onto the filtering membrane, during which the solutions undergo polycondensation to solidify into the active separating layer. The electrospray may be performed by an electrospinning machine having multiple nozzles and syringe pumps. In some embodiments the working voltage of the electrospinning machine may be in the range between 40-50 kV. In some embodiments the working distance of the electrospinning machine may be in the range of about 200-300 mm. In some embodiments the solution flow rate of the amine and acyl chloride solutions may be in the range of about 30-40 ml per hour per nozzle. The resulting active separating layer may have a thickness from about 1 nm to 1000 nm. The active separating layer may have pores or channels in the layer having a diameter between about 0.1 nm and 10 nm.

Once the membrane is prepared, the membrane may be washed in de-ionized water and dried in an oven. The membrane may then be implemented in a water filtration system for use in filtering industrial wastewater, such as in textile manufacturing.

Applicant presents the following exemplary manufacturing methods and resulting embodiments.

### Exemplary Embodiment 1A: PES Nanofiber Membrane

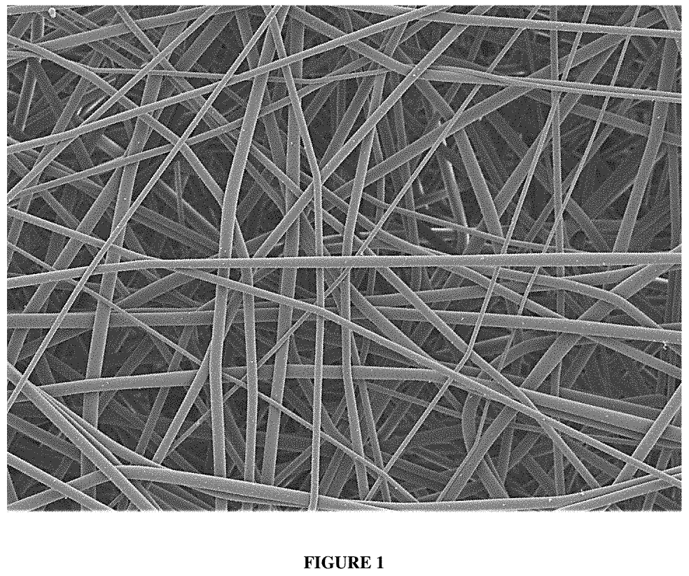

A PES nanofiber membrane may be prepared on a PET supporting fabric. The PES is dissolved in DMF solution, wherein the PES is 20% by weight to 30% by weight of the solution. More specifically, in the imaging depicted in FIG. 1 of the resulting PES membrane, a solution of PES at 25% by weight was used. The DMF/PES polymer solution was loaded into an electrospinning machine having the following working parameters. The working range of the applied voltage for the electrospinning process was between 40-50 kV. The working range was a distance of 150-200 mm. The solution flow rate into the nozzles was in the range of 0.5-1 ml per hour per nozzle. The electrospinning machine may have multiple nozzles (e.g., 4-8 nozzles on a multi-nozzle machine may be used). The resulting PES polymer membrane applied to the PET supporting material is depicted in FIG. 1, which shows an SEM microscopic image at 1000× magnification of PES nanofiber using a 25% PES in DMF solution.

### Exemplary Embodiment 1B: PES Nanofiber Membrane

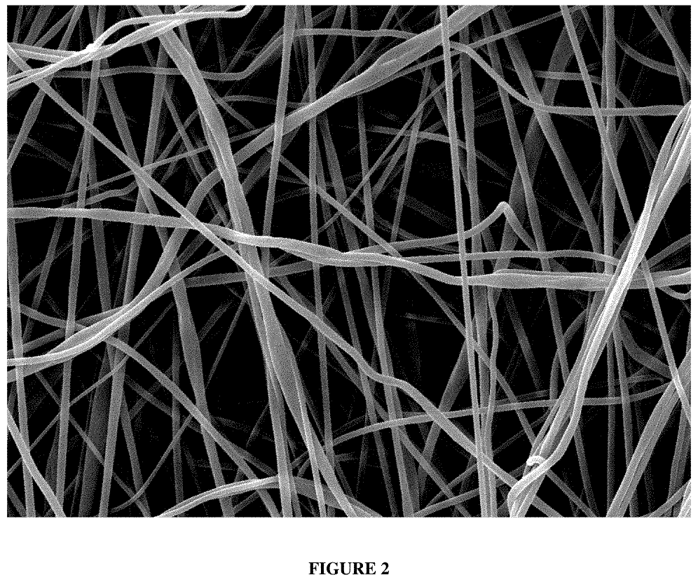

A PES nanofiber membrane may be prepared on a PET supporting fabric. The PES is dissolved in DMAc solution, wherein the PES is 20% by weight to 30% by weight of the solution. More specifically, in the imaging depicted in FIG. 2 of the resulting PES membrane, a solution of PES at 23% by weight was used. The DMAc/PES polymer solution was loaded into an electrospinning machine set to the following working parameters. The working range of the applied voltage for the electrospinning process was between 40-50 kV. The working range was a distance of 150-200 mm. The solution flow rate into the nozzles was in the range of 0.5-1 ml per hour per nozzle. The electrospinning machine may have multiple nozzles (e.g., 4-8 nozzles on a multi-nozzle machine may be used). The resulting PES polymer membrane applied to the PET supporting material is depicted in FIG. 2, which shows an SEM microscopic image at 5000× magnification of PES nanofiber using a 23% PES in DMAc solution.

### Exemplary Embodiment 2A: Nanoporous Polyamide Membrane

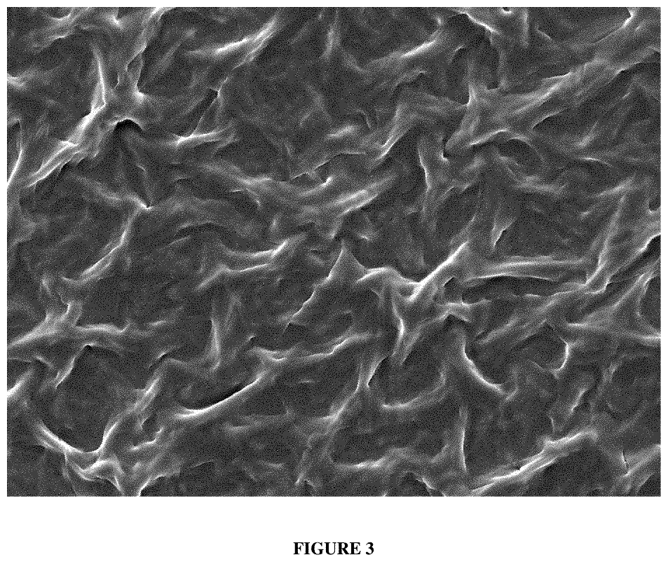

A nanoporous polyamide membrane for active separating may be prepared for application on a PES filtering membrane. A solution of 1.5% by weight TEGDA is dissolved in de-ionized water. A solution of 0.15% by weight TMC is dissolved in hexane. The aqueous and hexane solutions are loaded into an electrospinning machine in separate syringes for spinning by separate nozzles. The solutions are electrosprayed contemporaneously onto a PES filtering membrane and support fabric set to the following working parameters. The working range of the applied voltage for the electrospraying process was between 40-50 kV. The working range was a distance of 200-300 mm. The solution flow rate into the nozzles was in the range of 30-40 ml per hour per nozzle. In this process, two nozzles were used, one for the aqueous solution and one for the hexane solution. The resulting polyamide membrane is depicted in FIG. 3, which shows an SEM microscopic image at 1000× magnification.

### Exemplary Embodiment 2B: Nanoporous Polyamide Membrane

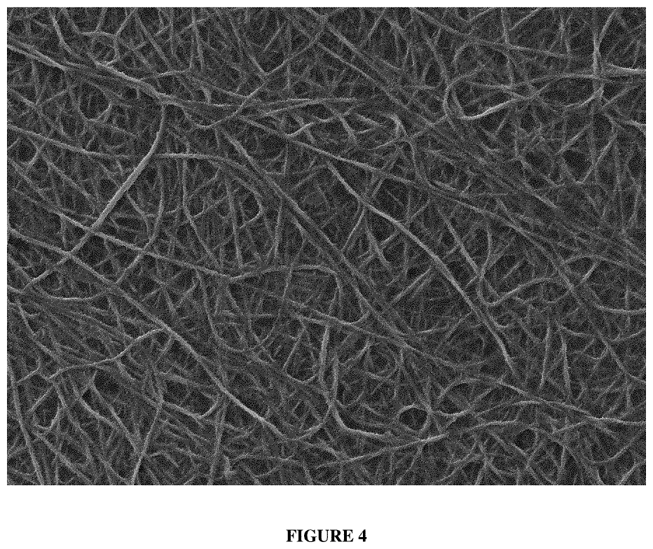

A nanoporous polyamide membrane for active separating may be prepared for application on a PES filtering membrane. A solution of 1.5% by weight DETA is dissolved in de-ionized water. A solution of 0.15% by weight TMC is dissolved in hexane. The aqueous and hexane solutions are loaded into an electrospinning machine in separate syringes for spinning by separate nozzles. The solutions are electrosprayed contemporaneously onto a PES filtering membrane and support fabric set to the following working parameters. The working range of the applied voltage for the electrospraying process was between 40-50 kV. The working range was a distance of 200-300 mm. The solution flow rate into the nozzles was in the range of 30-40 ml per hour per nozzle. In this process, two nozzles were used, one for the aqueous solution and one for the hexane solution. The resulting polyamide membrane is depicted in FIG. 4, which shows an SEM microscopic image at 1000× magnification.

### Exemplary Embodiment 2C: Nanoporous Polyamide Membrane

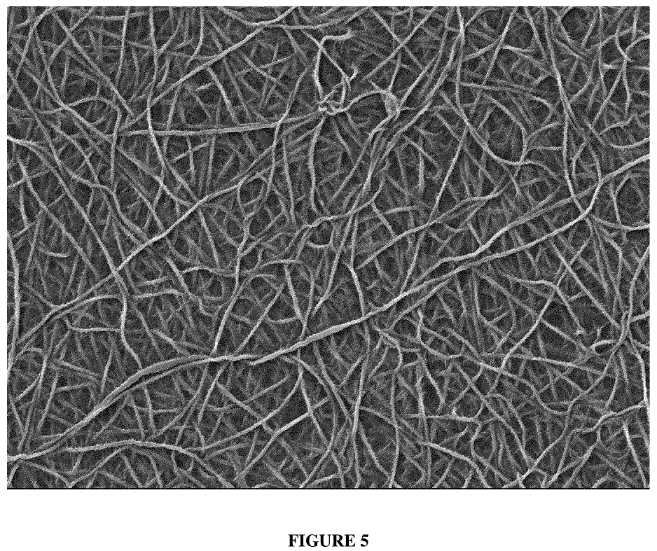

A nanoporous polyamide membrane for active separating may be prepared for application on a PES filtering membrane. A solution of 1.5% by weight of mixed DETA and TEGDA in a mix ratio of 4:6 is dissolved in de-ionized water. A solution of 0.15% by weight TMC is dissolved in hexane. The aqueous and hexane solutions are loaded into an electrospinning machine in separate syringes for spinning by separate nozzles. The solutions are electrosprayed contemporaneously onto a PES filtering membrane and support fabric set to the following working parameters. The working range of the applied voltage for the electrospraying process was between 40-50 kV. The working range was a distance of 200-300 mm. The solution flow rate into the nozzles was in the range of 30-40 ml per hour per nozzle. In this process, two nozzles were used, one for the aqueous solution and one for the hexane solution. The resulting polyamide membrane is depicted in FIG. 5, which shows an SEM microscopic image at 1000× magnification.

### Exemplary Embodiment 2D: Nanoporous Polyamide Membrane

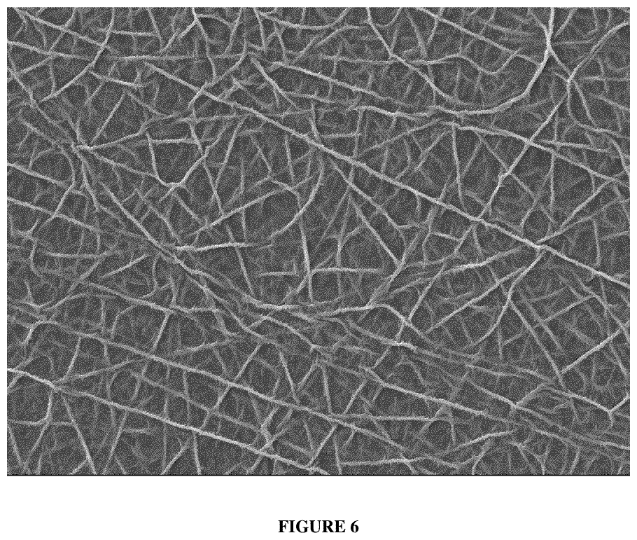

A nanoporous polyamide membrane for active separating may be prepared for application on a PES filtering membrane. A solution of 1.5% by weight of mixed DETA and TEGDA in a mix ratio of 3:7 is dissolved in de-ionized water. A solution of 0.15% by weight TMC is dissolved in hexane. The aqueous and hexane solutions are loaded into an electrospinning machine in separate syringes for spinning by separate nozzles. The solutions are electrosprayed contemporaneously onto a PES filtering membrane and support fabric set to the following working parameters. The working range of the applied voltage for the electrospraying process was between 40-50 kV. The working range was a distance of 200-300 mm. The solution flow rate into the nozzles was in the range of 30-40 ml per hour per nozzle. In this process, two nozzles were used, one for the aqueous solution and one for the hexane solution. The resulting polyamide membrane is depicted in FIG. 6, which shows an SEM microscopic image at 1000× magnification.

### Exemplary Embodiment 2E: Nanoporous Polyamide Membrane

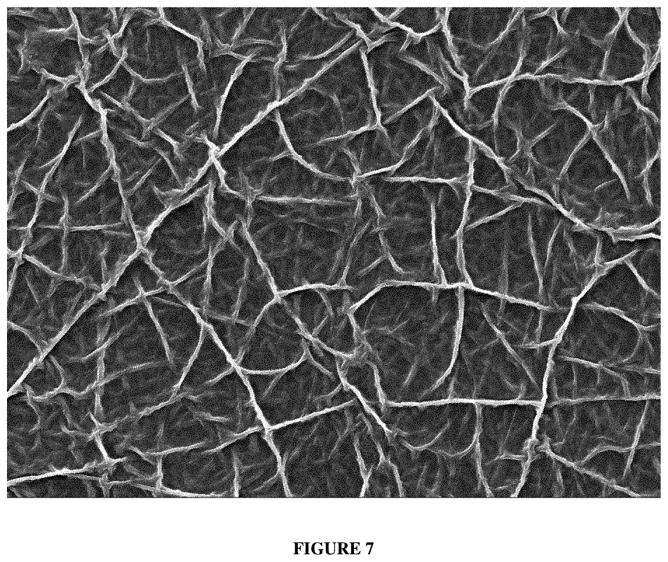

A nanoporous polyamide membrane for active separating may be prepared for application on a PES filtering membrane. A solution of 1.5% by weight of mixed DETA and TEGDA in a mix ratio of 2:8 is dissolved in de-ionized water. A solution of 0.15% by weight TMC is dissolved in hexane. The aqueous and hexane solutions are loaded into an electrospinning machine in separate syringes for spinning by separate nozzles. The solutions are electrosprayed contemporaneously onto a PES filtering membrane and support fabric set to the following working parameters. The working range of the applied voltage for the electrospraying process was between 40-50 kV. The working range was a distance of 200-300 mm. The solution flow rate into the nozzles was in the range of 30-40 ml per hour per nozzle. In this process, two nozzles were used, one for the aqueous solution and one for the hexane solution. The resulting polyamide membrane is depicted in FIG. 7, which shows an SEM microscopic image at 1000× magnification.

Combination of Layers

Based on the above processes and as shown in the exemplary embodiments, a resulting filtration membrane may be prepared having a nonwoven fabric support layer, a nanofibrous filtering membrane layer, and a nanoporous polyamide active separating layer. The various exemplary embodiments above may be combined to produce various resulting filtration membranes.

For example the process of exemplary embodiment 1A for preparing the PES membrane on PET may be combined with the process of exemplary embodiment 2A for preparing the polyamide membrane.

The process of exemplary embodiment 1A for preparing the PES membrane on PET may be combined with the process of exemplary embodiment 2B for preparing the polyamide membrane.

The process of exemplary embodiment 1A for preparing the PES membrane on PET may be combined with the process of exemplary embodiment 2C for preparing the polyamide membrane.

The process of exemplary embodiment 1A for preparing the PES membrane on PET may be combined with the process of exemplary embodiment 2D for preparing the polyamide membrane.

The process of exemplary embodiment 1A for preparing the PES membrane on PET may be combined with the process of exemplary embodiment 2E for preparing the polyamide membrane.

The process of exemplary embodiment 1B for preparing the PES membrane on PET may be combined with the process of exemplary embodiment 2A for preparing the polyamide membrane.

The process of exemplary embodiment 1B for preparing the PES membrane on PET may be combined with the process of exemplary embodiment 2B for preparing the polyamide membrane.

The process of exemplary embodiment 1B for preparing the PES membrane on PET may be combined with the process of exemplary embodiment 2C for preparing the polyamide membrane.

The process of exemplary embodiment 1B for preparing the PES membrane on PET may be combined with the process of exemplary embodiment 2D for preparing the polyamide membrane.

The process of exemplary embodiment 1B for preparing the PES membrane on PET may be combined with the process of exemplary embodiment 2E for preparing the polyamide membrane.

Manufacture of Membrane

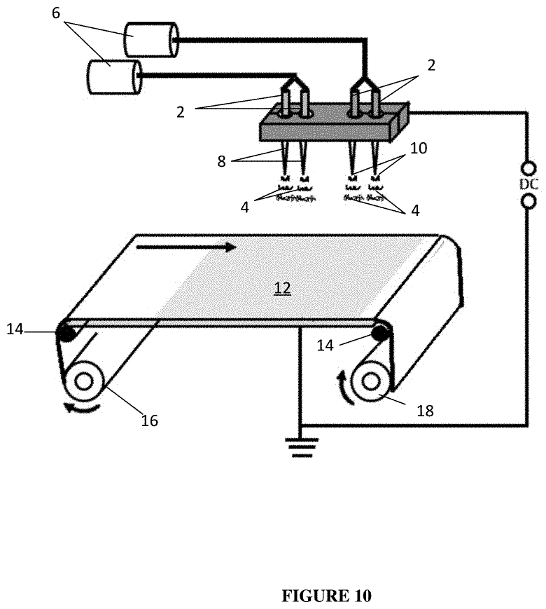

The nanofiber filtering membrane and active separating layer are each applied as described above using electrospraying and electrospinning fabrication techniques. These are related techniques performed using the same basic equipment. An equipment schematic is provided as FIG. 10 and described herein for the purpose of providing additional context to the manufacturing description above. A syringe 2 is filled with an electrically charged liquid solution 4 that includes the material (e.g., the PES or polyamide fibers) that will form the desired layers, suspended or dissolved in the solution. A pump 6 supplies a consistent pressure to force the solution 4 out of the syringe 2 at a desired constant rate through a cone or nozzle 8. The cone ends in an electrically charged spinneret 10 that spins to stretch and draw the liquid solution droplets into long, thin threads having nanoscale diameters. The solution is directed towards a negative or grounded collector 12. In the case of application of the filtering membrane, the collector 12 is the nonwoven fabric layer. In the case of application of the active filtering layer, the collector 12 is the combination nonwoven fabric layer plus the filtering membrane layer. As the solution erupts from the spinneret 10, the liquid solution may remain in a long thread or break up into droplets, depending on the electrostatic properties of the liquid solution and the velocity of the charged solution stream. If the fibers remain in a long thread and are applied to the collector 12 in that manner, the process is known as electrospinning. If the fibers break up into droplets and are applied to the collector in that manner, the process is known as electrospraying. The voltage differential between the charged needle and spinneret on the one hand and the collector on the other hand is typically in the range of 40-50 kV for the processes described herein. A large-scale production machine for use in industrial electrospinning or electrospraying techniques may include multiple sets of syringes and nozzles applying the charged solution to either a single large collector or to multiple collectors, depending on the desired size of the fabricated material. Furthermore, for a mass-produced membrane, the nonwoven fabric acting as the collector 12 may be provided on rollers 14 between a first spool 16 and a second spool 18 such that the added membrane layers are applied over the rolling sheet of fabric.

Controlling Hydrophilicity of Polyamide Membrane Layer

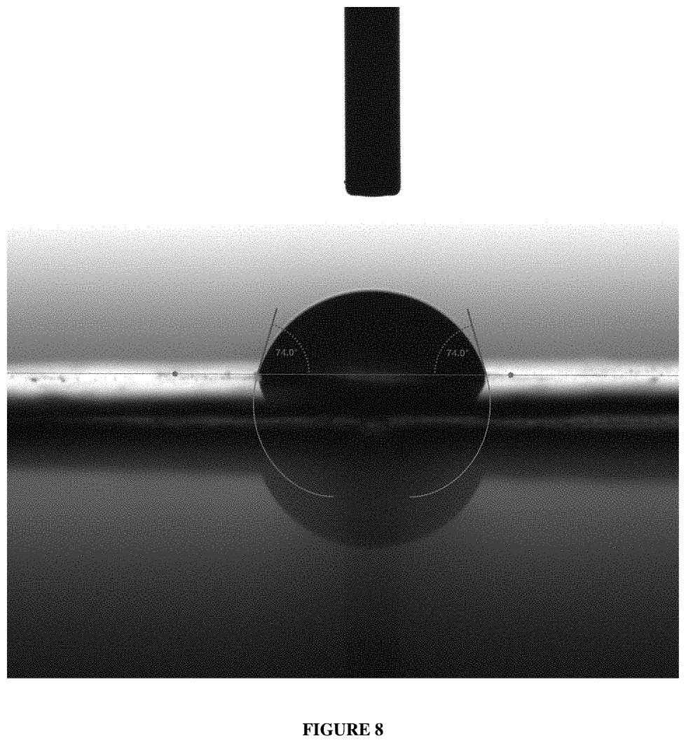

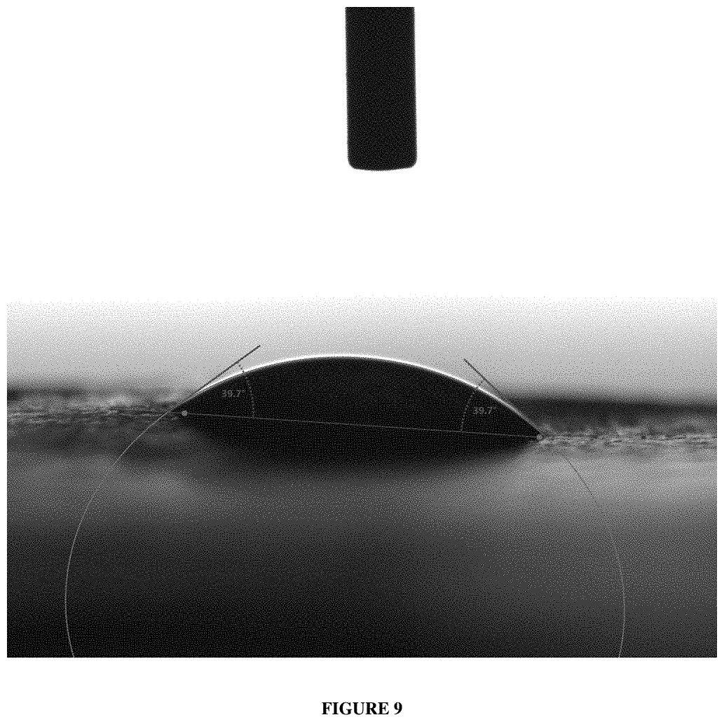

The polyamide membrane active separating layer is hydrophilic. The polyamide membrane layer may be modified in its composition or surface roughness to select a variable hydrophilicity. For example, the use of DETA and/or TEGDA, or the mix ratio of those two solutes, may be modified to change the hydrophilicity of the membrane as desired. The hydrophilicity of the polyamide membrane layer may be measured with a contact angle goniometer applying a water droplet as small as 1 microliter on the membrane surface using the sessile drop technique. A high-resolution camera may then capture an image of the water droplet and the contact angle may be measured. For clarity, a surface is hydrophilic if the contact angle is less than 90 degrees. The image shown in FIG. 8 shows a water drop captured according to the above technique and having a contact angle of 74.0 degrees on a smooth surface. A rougher surface exhibits a higher hydrophilicity, as demonstrated by the flatter droplet profile in FIG. 9. The image shows a water contact angle of 39.7 degrees on a rough surface.

Permeability of Membrane

The three-layer membrane disclosed herein has a high water flux rate. For testing permeability, a chamber having an opening to a graduated cylinder was provided, with the membrane cut and sized to cover the opening. A sealing O-ring sealed the chamber and opening. The membrane was positioned and oriented such that the side having the polyamide membrane faced into the chamber. Pure water was pumped into the testing chamber with the pressure at 0 MPa. Water filled the chamber and flowed through the membrane for a period of 10 minutes at zero pressure to stability flow through the membrane. Then the pressure was set to 0.48 MPa. The volume of water forced through the membrane over a set time was then determined. Using this standard, the pure water flux rate for the membrane described herein was measured to be 40-200 liters per square meter per hour, depending on the fabrication of the membrane using different reagent solutions as described above.

Membrane Performance

Membranes prepared as described above have a rejection rate of sodium chloride at the value range between 10-85%, depending on the fabrication of the membrane using different reagent solutions as described above, with inlet sodium chloride concentration of 2000 ppm. Membranes further have a rejection rate of magnesium sulphate at the value range between 80-97% with inlet magnesium sulphate concentration of 2000 ppm, depending on the fabrication of the membrane using different reagent solutions as described above.

It is to be noted here that the present products and methods are not limited to the preceding exemplary embodiments or products having the tested parameters or characteristics described above, and various changes and modifications can be made within the scope not departing from the gist of the present teachings. The description of exemplary embodiments is provided to enable a person skilled in the art to make and use the present product. Moreover, various modifications to these exemplary embodiments will be readily apparent to those skilled in the art, and the generic principles and specific examples defined herein may be applied to other embodiments without the use of inventive faculty. Therefore, the present claimed invention is not intended to be limited to the exemplary embodiments described herein but is to be accorded the widest scope as defined by the limitations of the claims and equivalents. Further, it is noted that the inventors' intent is to retain all equivalents of the claimed invention even if the claims are amended during prosecution.

We claim:

1. A method for manufacturing a nanofiltration membrane comprising:
providing a support layer of nonwoven fabric;
electrospinning a polysulfone filtering membrane layer onto the support layer; and
electrospraying a nanoporous polyamide membrane active separating layer onto the filtering membrane layer.

2. The method of claim 1, wherein the support layer is a PET fabric.

3. The method of claim 1, wherein the filtering membrane layer is formed of polyethylsulfone (PES) nanofibers.

4. The method of claim 3, wherein the PES is injected into an electrospinning machine as dissolved in a DMF solution with 20-30% by weight PES.

5. The method of claim 3, wherein the PES is injected into an electrospinning machine as dissolved in a DMAc solution with 20-30% by weight PES.

6. The method of claim 3, wherein the PES layer comprise fibers having a diameter between 100 nm and 1000 nm.

7. The method of claim 3, wherein the PES layer comprises fibers having pores with a diameter between 1 nm and 100 nm.

8. The method of claim 3, wherein the electrospinning of PES is implemented with a working distance of 150 to 200 mm.

9. The method of claim 3, wherein the electrospinning of PES is implemented with a working voltage between 40 to 50 kV.

10. The method of claim 3, wherein the electrospinning of PES is implemented with multiple nozzles at a feeding rate between 0.5 to 1 ml per hour per nozzle.

11. The method of claim 2, wherein the filtering membrane layer is formed of PES nanofibers.

12. The method of one of claim 3, wherein the active separating layer is made by polymer condensation of molecules of DETA and/or TEGDA, and TMC.

13. The method of claim 12, wherein the concentration of DETA and/or TEGDA in aqueous solution is 1.5-3% by weight.

14. The method of claim 12, wherein the concentration of TMC in hexane solution is 0.1-0.5% by weight.

15. The method of claim 12, wherein the electrospraying is implemented with a working distance of 200 to 300 mm.

16. The method of claim 12, wherein the electrospraying is implemented with a working voltage between 40 to 50 kV.

17. The method of claim 12, wherein the electrospraying is implemented with multiple nozzles at a feeding rate between 20 to 40 ml per hour per nozzle.

18. The product prepared by the method of claim 1.

19. The product prepared by the method of claim 3.

20. The product prepared by the method of claim 12.

21. The product of claim 20, wherein the pure water flux rate of the product at 0.48 MPa is between 40-200 liters per square meter per hour.

22. The product of claim 20, wherein the contact angle of a water droplet in a sessile drop test is less than 90 degrees.

23. The product of claim 20, wherein the contact angle of a water droplet in a sessile drop test is less than 80 degrees.

24. The product of claim 20, wherein the contact angle of a water droplet in a sessile drop test is less than 50 degrees.

25. The product of claim 20, wherein the membrane has a rejection rate of sodium chloride of 10-85% with inlet sodium chloride concentration of 2000 ppm.

26. The product of claim 20, wherein the membrane has a rejection rate of magnesium sulphate of 80-97% with inlet magnesium sulphate concentration of 2000 ppm.

27. A filtration membrane comprising:
a support layer of nonwoven fabric;
a nanofiber polysulfone filtering membrane layer applied to a surface of the support layer; and
a nanoporous polyamide membrane active separating layer.

28. The membrane of claim 27, wherein the support layer is a PET fabric.

29. The membrane of claim 28, wherein the filtering membrane layer is formed of polyethylsulfone (PES) nanofibers.

30. The membrane of claim 29, wherein the PES layer comprises fibers having a diameter between 100 nm and 1000 nm.

31. The membrane of claim 29, wherein the PES layer comprises fibers having pores with a diameter between 1 nm and 100 nm.

32. The membrane of claim 27, wherein the active separating layer is made by polymer condensation of molecules of DETA and/or TEGDA, and TMC.

33. The membrane of claim 32, wherein the pure water flux rate of the product at 0.48 MPa is between 40-200 liters per square meter per hour.

34. The membrane of claim 32, wherein the contact angle of a water droplet in a sessile drop test is less than 90 degrees.

35. The membrane of claim 32, wherein the contact angle of a water droplet in a sessile drop test is less than 80 degrees.

36. The membrane of claim 32, wherein the contact angle of a water droplet in a sessile drop test is less than 50 degrees.

37. The membrane of claim 32, wherein the membrane has a rejection rate of sodium chloride of 10-85% with inlet sodium chloride concentration of 2000 ppm.

38. The membrane of claim 32, wherein the membrane has a rejection rate of magnesium sulphate of 80-97% with inlet magnesium sulphate concentration of 2000 ppm.
